(19) United States
(12) Patent Application Publication
(10) Pub. No.: US 2009/0234748 A1
(43) Pub. Date: Sep. 17, 2009

(54) INTERCHANGE FEE NOTIFICATION

(75) Inventors: Dan Skowronek, Parker, CO (US); Nicholas Bryla, Castle Rock, CO (US); Mira Olson, Boonsboro, MD (US); Christine Lopez, Parker, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Greenwood Village, CO (US)

(21) Appl. No.: 12/046,222

(22) Filed: Mar. 11, 2008

(51) Int. Cl. G06Q 20/00; G06Q 30/00; G06Q 10/00

(52) U.S. Cl. 705/21; 705/35; 705/39; 705/34

(57) ABSTRACT

The embodiments described provide for systems and methods that alert a merchant of increased interchange fees. An increased interchange fee occurs when an electronic transaction, such as a credit card transaction, deviates from a standard set of criteria. For example, the sales person enters the credit card number rather than swipe the magnetic stripe of the credit card. In one embodiment, transaction information is provided to a merchant. The merchant sends the transaction information to an application. If the transaction is non-standard, the application can produce a notification that is sent to the merchant. The merchant may then address the causes of the increased interchange fee.

### BACKGROUND

Merchants allow customers to purchase goods or services using credit cards or other non-cash electronic payment transactions. The companies that process the credit card transactions generally charge merchants a fee, called an interchange fee, for processing each transaction. The interchange fee charged on any given transaction can vary depending upon a number of criteria, but typically has an expected rate of, for example, 1.75% of the total amount of the transaction. The process of applying the interchange rate schedule to a merchant transaction is known as qualification. However, as the transaction characteristics vary from the anticipated qualification criteria, the interchange fee applied to the transaction can increase. The increase in the interchange fee helps offset the added risk or pay for additional cardholder benefits the company processing the transaction incurs because of the non-standard transaction.

For example, in a retail store, a merchant may consider a standard credit card transaction to be one that requires the customer or the sales associate to swipe the magnetic stripe of the credit card. The credit card number and other information is read from the magnetic stripe and passed through the point of sale equipment to the merchant acquirer. In this case, the capture and use of the magnetic stripe verifies that the credit card was physically present for the transaction and allows the transaction to qualify for a favorable interchange rate. The merchant, whose customers are physically present during a credit card transaction, would consider such a transaction to be their standard transaction and the associated interchange rate to be their standard interchange rate. The interchange rates considered to be standard will vary by merchant type, type of card holders that frequents the merchant (premium reward cards may charge a higher interchange rate) and the amount of information a merchant can gather from their customers in order to minimize transactional risk. A non-standard transaction may include the sales associate manually entering the credit card number rather than swiping the card. In this scenario, the risk that a fraudulent credit card is used for the transaction increases because the credit card is not present to verify the authenticity of the credit card number or the authenticity of the cardholder. As such, the company processing the credit card transaction may require a higher interchange fee to offset the risk of the non-standard transaction.

Increased interchange qualification fees can be the result of a number of factors and broadly fall into two categories: avoidable and unavoidable. If a merchant chooses to accept a particular brand of credit card from an organization, such as VISA or MasterCard, the merchant is often obligated by the association regulations to accept any validly presented consumer card. Unavoidable interchange qualification fee increases could result from the customer belonging to a premium card reward program. The merchant must accept the increased interchange fees on the atypical transactions in order to receive the general benefit of being able to accept credit card payments. On the other hand, for some transactions to which higher interchange fees are applied, the increased interchange rate is avoidable. In these cases, the merchant can act positively to address the issue and return the interchange fees to their expected/standard interchange qualification rates. For example, the magnetic stripe reader incorporated into a payment terminal or point of sale may be broken and unable to accurately read the magnetic stripes of the credit cards that are presented for consumer transactions. Similarly, untrained employees may be unaware that manually entering the number instead of swiping the credit card may cause higher fees. The merchant may be unaware that these situations creating non-standard transactions are occurring and increasing the merchant's costs for processing credit card transactions. In such cases, the merchant may not become aware there are problems with interchange qualification until they receive their monthly processing fee statement. The sooner the merchant identifies irregular and avoidable interchange qualification fees, the quicker they can address the issue and reduce the negative financial impact of these fees.

It is in view of these and other considerations not mentioned herein that the embodiments of the present disclosure were envisioned.

### SUMMARY

Embodiments presented herein provide for systems and methods that alert a merchant of increased interchange fees. In one embodiment, transaction information is provided to a merchant. The merchant sends the transaction information to an application. If the transaction is non-standard, the application can produce a notification that is sent to the merchant. The merchant may then address the causes of the increased interchange fee. The embodiments provide an active management approach to interchange fees.

This summary is not meant to limit the scope of the disclosure. The disclosure is as defined in the claims.

### BRIEF DESCRIPTION OF THE DRAWINGS

The embodiments of the present disclosure are described in conjunction with the appended figures:

FIGS. 1A and 1B are block diagrams of embodiments of systems for alerting merchants of the incidence of one or more increased interchange fees;

FIG. 2 is a block diagram of an embodiment for determining that an interchange fee will be assessed and notifying the merchant;

FIGS. 3A and 3B are flow diagrams of embodiments of methods or processes for sending a notice that a higher interchange fee will be assessed for one or more transactions;

FIG. 4 is a flow diagram of an embodiment of a method or process for sending a notice that a higher interchange fee will be assessed for one or more transactions;

FIG. 5 is a block diagram of an embodiment of a computing system that may be used as a system for notifying a merchant of an increased interchange fee; and

FIG. 6 is a block diagram of an embodiment of a criteria database used to evaluate transactions.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

The ensuing description provides exemplary embodiment(s) only and is not intended to limit the scope, applicability or configuration of the possible embodiments. Rather, the ensuing description of the exemplary embodiment(s) will provide those skilled in the art with an enabling description for implementing an exemplary embodiment. It being understood that various changes may be made in the function and arrangement of elements without departing from the spirit and scope of the possible embodiments as set forth in the appended claims.

Embodiments of the present disclosure provide a unique and novel system for determining that an increased interchange fee will be assessed for a transaction and notifying the merchant of the increased interchange fee. As an example, a sales person at a register in a store asks for payment for a good. The customer provides a credit card to complete the purchase. The sales person attempts to swipe the credit card in a credit card reader. If the credit card number does not register through the card reader, the sales person may enter the credit card number manually using a keypad or other interface.

The transaction information, such as the credit card number, an indication that the credit card number was entered manually, the amount of the purchase, etc., is sent to an application. The application evaluates the transaction information. The application determines if the transaction matches the standard interchange qualification for the merchant. The credit card number entered for the transaction was entered manually, which the application recognizes as a non-standard transaction. A non-standard transaction generally incurs an increased interchange fee. As such, the application generates a notice of an increased interchange fee. The notice can be sent to a responsible person at the merchant, such as a store manager. The store manager then has information about the increased interchange fee and can respond to the notice. In embodiments, the store manager receives notices of avoidable interchange fee increases to address those increases but does not receive notices for unavoidable interchange fee increases. For example, the store manager may check if the credit card reader is malfunctioning or if the sales person requires more training on the credit card reader. Especially since the notice can be generated in near real time, the merchants can respond to events that create increased interchange fees before those events create more costs to the merchant.

Specific details are given in the following description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments. In some embodiments, a computing system may be used to execute any of the tasks or operations described herein. In embodiments, a computing system includes memory and a processor and is operable to execute computer-executable instructions stored on a computer readable medium that define processes or operations describe herein.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in the figure. A process may correspond to a method, a function, a procedure, a subroutine, a subprogram, etc. When a process corresponds to a function, its termination corresponds to a return of the function to the calling function or the main function.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to, portable or fixed storage devices, optical storage devices, wireless channels and various other mediums capable of storing, containing or carrying instruction(s) and/or data.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine-readable medium such as storage medium. A processor(s) may perform the necessary tasks. A code segment may represent a procedure, a function, a subprogram, a program, a routine, a subroutine, a module, an object, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

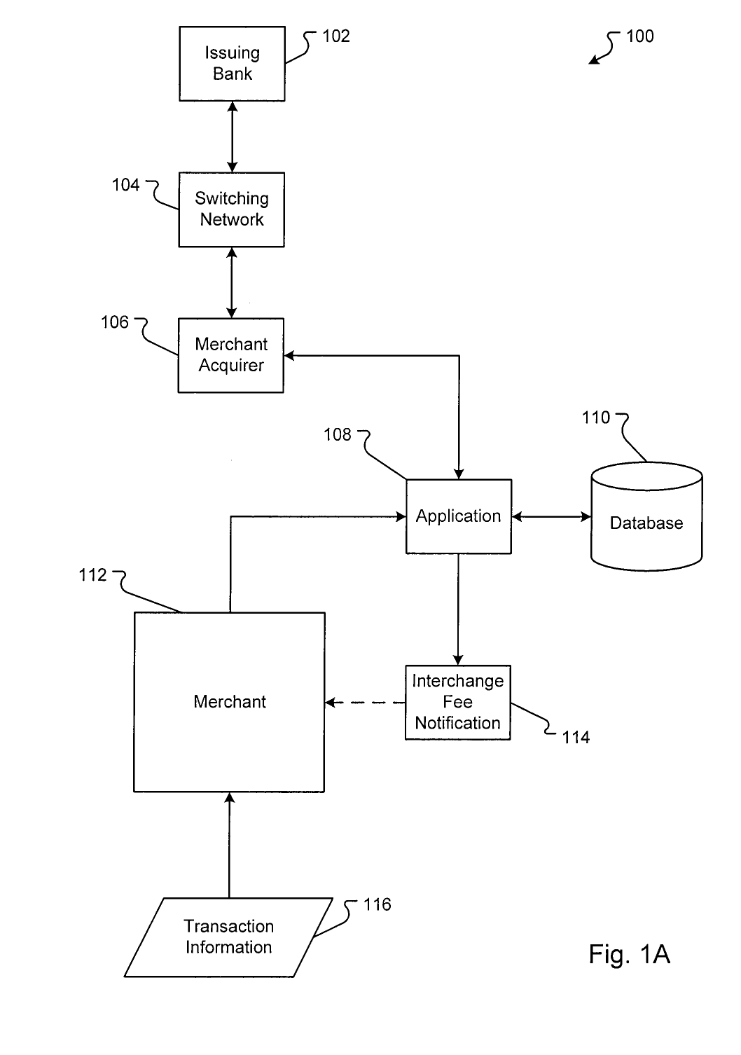

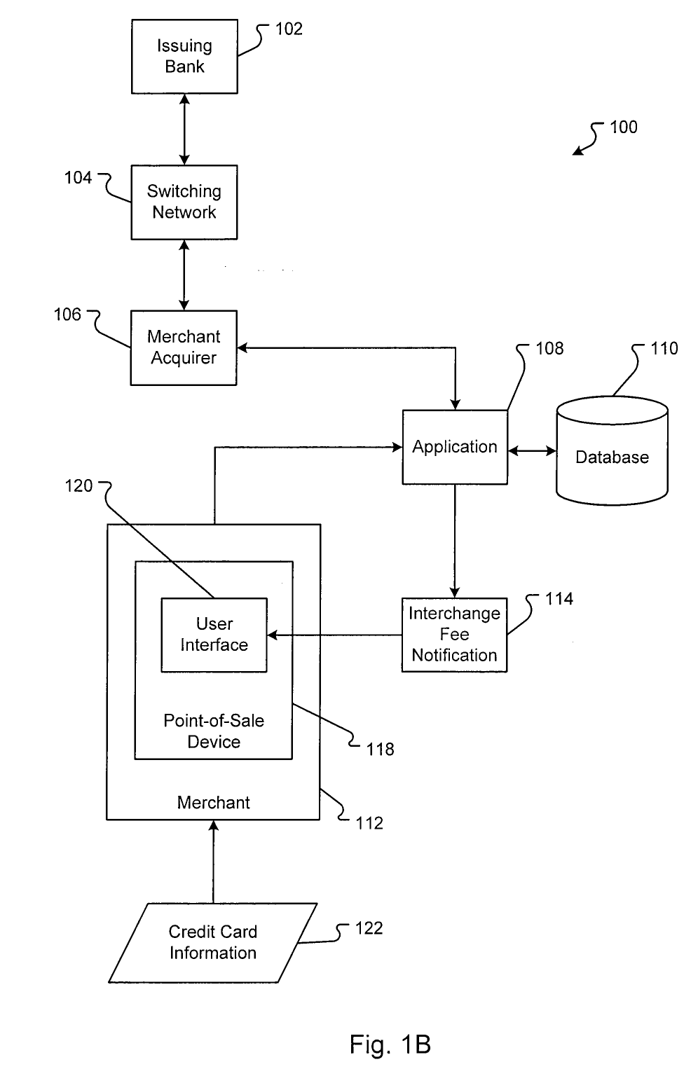

An embodiment of a system 100 operable to generate the notices of increased interchange fees is shown in FIG. 1A. The merchant 112 is any store, retailer, online retailer, or other company or entity that transacts business or processes financial information. A financial transaction may include, but is not limited to, a purchase of a good, a purchase of a service, or a receipt of a charitable donation. The merchant 112 includes any system, either hardware, software, or hardware and software, that the merchant uses to process a financial transaction. For example, the merchant 112 may include the point-of-sale device 118 that is used to read the magnetic stripe on the credit card and/or the routers, servers, and network that sends the transaction information to the merchant acquirer 106, which processes the transaction. The merchant 112 and the systems associated therewith are well known in the art and will not be explained further.

The merchant 112 can receive transaction information 116. Transaction information 116 is one or more items of information provided by the customer to complete the transaction. In embodiments, the transaction information 116 includes, but is not limited to, a credit card number, a debit card number, a stored value card number, the customer's name, authentication information, such as the customer's address, zip code, phone number, etc., the amount of the purchase, an indication of how the transaction information was received, or the goods or services purchased. The transaction information 116 may be received electronically from a point-of-sale device, online from a customer computer, transmitted from a mobile device, entered manually into a merchant system 100, or by other method or process.

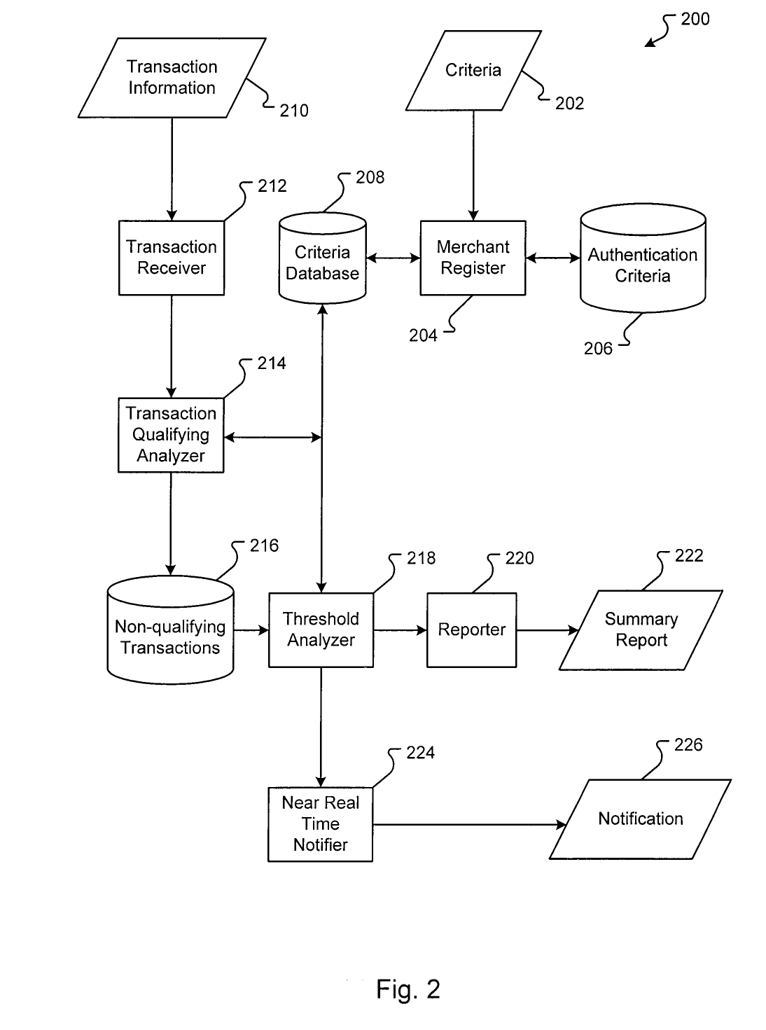

The merchant 112 can send the transaction information 116 to an application 108. In embodiments, the application 108 is the hardware, software, or hardware and software that evaluates the transaction information 116 to determine if an increased interchange fee will be assessed. An embodiment of an application 108 is described in conjunction with FIG. 2. In embodiments, the application 108 may be part of the merchant 112, part of a point-of-sale device at the merchant, a stand-alone application, or part of the merchant acquirer 106. If the application 108 is part of the merchant 112, no message may be sent to the merchant acquirer until the increase in interchange fee is accepted. The application 106 and merchant 108 may be connected and communicate with a network. The network may include a local area network (LAN), wherein the application 108 and merchant 112 are collocated in the same physical site and on the same network, a wide area network (WAN), a wireless LAN or WAN, the Internet, etc.

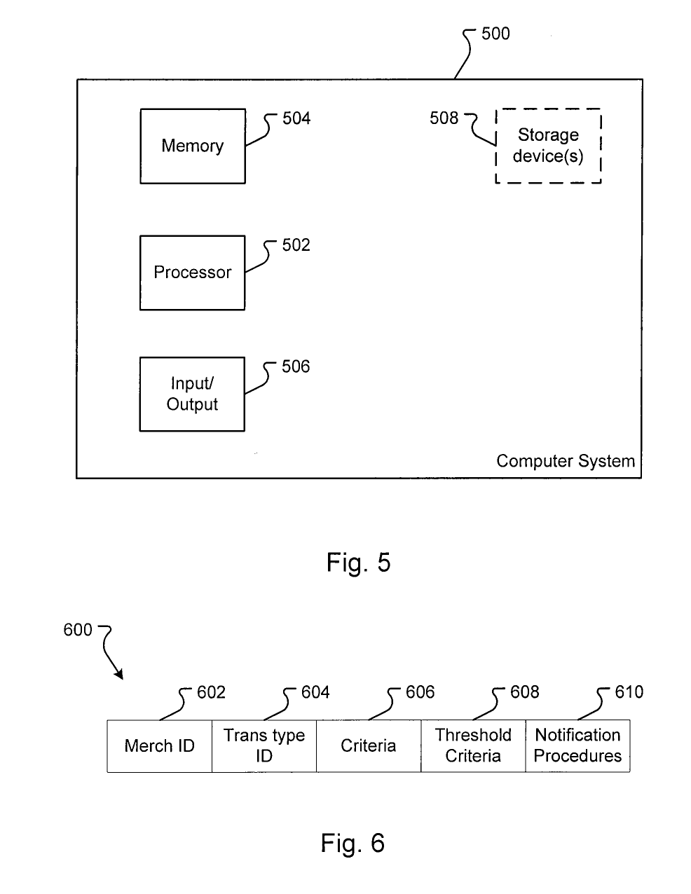

In embodiments, the application 108 interfaces with a database 110. The database 110 can be any hardware, software, or hardware and software used to store information. For example, the database 110 is a collection of information stored in a relational database on a hard drive or other memory described in conjunction with FIG. 5. The database 110 can include information used by the application 108 for comparing to the transaction information 116. The information in the database 110 allows the application 108 to determine if the transaction will create an increased interchange fee. In alternative embodiments, all transaction information, including standard and non-standard transactions and any declined or authorized transactions are sent to the database 110. The transaction information may also come from the merchant acquirer 106 before or after receiving an authorization or declination from the issuing institution 102 or the information may come from the issuing institution 102 directly. The application 108 may then analyze all the transactions created by the merchant for patterns in how increased interchange fees are created. Having all transaction information may reveal problems between authorization and settlement amounts or time lags between authorizations and settlement times.

The merchant acquirer 106, in embodiments, is an entity that processes credit or debit or other financial transaction authorizations on behalf of a merchant 112 desiring to accept payment from network based payment systems such as credit, debit, stored value, etc. The merchant acquirer 106 may communicate authorization requests and receive authorizations or declinations of payment for a merchant over a payment switching network 104 (e.g., VISA® or MASTERCARD®). In other embodiments, the merchant acquirer 106 may be a function of a financial institution, for example, a bank, that processes credit or debit authorization requests without a separate outside entity. The merchant acquirer 106 may have a predefined relationship with the merchant 112 or customer providing the transaction information 116. In embodiments, a merchant acquirer 106 sends an authorization request to a consumer payment issuing bank 102. The issuing bank 102, in embodiments, is a financial institution that approves transactions for a consumer and sends authorizations to the merchant acquirer 106.

The merchant acquirer 106 receives the transaction information 116. In embodiments, the merchant acquirer 106 validates the authenticity of the transaction. The merchant acquirer 106 may then send an authorization request to the issuing bank 102 to approve the transaction by determining if the consumer can pay for the transaction. The issuing bank 102 may then issue an authorization to the merchant acquirer 106. In embodiments, the merchant acquirer 106 sends the authorization to the merchant 112.

In operation, the merchant 112 receives transaction information 116 from a customer. The transaction information 116 is sent to the application 108, which evaluates the transaction information 116 against information in the database 110. If the transaction will create an increased interchange fee, the application 108 generates and sends the interchange fee notification 114. In embodiments, the interchange fee notification 114 is sent to the merchant 112 from which the transaction information 116 was received.

A store manager or other responsible party may receive the interchange fee notification 114. The interchange fee notification 114 may be an email or other electronic alert sent to a computer of a responsible party. The interchange fee notification 114 may have enough information to identify possible problems while protecting the customer's privacy. For example, the cardholder's name, address, and other personal information may not be disclosed in the interchange fee notification 114. One skilled in the art will recognize what information may be disclosed or not disclosed while protecting the cardholder's privacy. In alternative embodiments, the interchange fee notification 114 is sent to a sales person to alert the sales person of the increased interchange fee. In still another embodiment, the interchange fee notification 114 is a report produced periodically for the merchant 112. If the transaction continues, the application 108 sends the transaction information 116 to the merchant acquirer 106. Alternatively, the transaction information 116 is sent to the merchant acquirer 106 and the application 108 substantially at the same time. In embodiments, the notification 114 also includes predicted or possible causes for the increased interchange fees and one or more proposed solutions to eliminate the predicted causes.

Another embodiment of the interchange fee notification system 100 is shown in FIG. 1B. In embodiments, the merchant 112 includes a point-of-sale device 118. The point-of-sale device 118 can be any electronic cash register or terminal that processes transactions. The point-of-sale device 118, in embodiments, receives credit card information 122, which is a form of transaction information 116 (FIG. 1A). Thus, the point-of-sale device 118 can include a magnetic stripe reader or other device to obtain the credit card number. In an embodiment, a user interface 120 is included with the point-of-sale device 118 to allow a sales person to enter information into the point-of-sale device 118. The user interface 120 is any user interface 120 as described in conjunction with FIG. 5. For example, the user interface 120 includes a display, a keyboard, a mouse, a touch screen, a scanner, or other device that displays information and/or allows a sales person to enter information into the point-of-sale device 118.

In operation, a sales person may enter the credit card information 122 using the user interface 120 of the point-of-sale device 118. The credit card information 122 and any other transaction information is sent from the point-of-sale device 118 to the application 108. The application 108 again analyzes the transaction against information in the database 110. If the transaction is non-standard, the application 108 may generate an interchange fee notification 114 and, in embodiments, sends the interchange fee notification 114 to the point-of-sale device 118 to be displayed at the user interface 120. The sales person may then be provided the notice of the increased interchange fee before the transaction is completed or in “near real time.” Near real time can mean an action that occurs quickly or when a person can react to the action during the transaction. In embodiments, the sales person must acknowledge the notice by using the user interface 120 to accept the increased interchange fee. In other embodiments, the sales person cannot continue the transaction without accepting the increased interchange fee. As such, the merchant 112 can have granular and real time control over whether increased interchange fees are accepted. In embodiments, the application 108 may be resident in the merchant. While the application 108 may report the transaction to a clearing house or other entity to analyze the transaction, no transaction information may be sent to the merchant acquirer 106 until, at least, the transaction and increased interchange fee is approved.

An embodiment of one or more components that may form the application 200 (similar or the same as application 108 in FIGS. 1A and 1B) is shown in FIG. 2. The components described in conjunction with FIG. 2 may be hardware, software, or hardware and software operable to perform the functions described herein. In embodiments, the components are software modules executed in a processor as described in conjunction with FIG. 5. In embodiments, the application 200 includes a merchant register 204 which accepts criteria 202. The merchant register 204 interfaces with one or more merchants 112 (FIG. 1A), The merchant register 204 may interface with a store manager, district sales manager, a company sales manager, or other person or entity to receive criteria 202. As such, the criteria 202 used to evaluate whether transactions are standard can be set at the store level, district level, company level, or any other level of granularity.

In embodiments, when a merchant first interfaces with the merchant register 204, one or more items of authentication criteria 206 are stored. The authentication criteria 206 allows the merchant register 204 to maintain the criteria in a secure fashion by having the merchant authenticate itself before changing, adding, or eliminating criteria. The merchant register 204 reads the authentication criteria 206 and evaluates information provided by the merchant to authenticate the merchant before allowing a session.

The merchant register 204 receives one or more items of criteria 202. Criteria 202 are, in embodiments, a set of information for which the application 200 will use to evaluate transactions. In embodiments, the criteria are the information for a standard transaction, for example, magnetic stripe read, card present, card type(s), transaction classifications, zip code entered, etc. The criteria 202 may be associated with an agreement with a merchant acquirer 106 (FIG. 1A) about how credit card or other transactions will be processed. The criteria are received by the merchant register 204 and stored in a criteria database 208. The criteria database 208 is, in embodiments, a memory storing the criteria 202. The criteria can be stored in a relational database or other data structure. In embodiments, the criteria database 208 is accessible to one or more computers over a network.

An embodiment of the criteria database 600 (similar or same as criteria database 206) includes one or more data records related to a merchant and as shown in FIG. 6. Each data record may include one or more data fields. A first data field may include a merchant identifier 602. The merchant payment acceptance device identifier 602 (Merch ID in FIG. 6) may be any unique identifier, such as a unique number or name, that identifies to which merchant the criteria are associated. Therefore, each merchant can have a customizable set of criteria by which to analyze transactions. The same criteria can be applied across all payment acceptance devices operated by a merchant, can be customized down to the individual payment acceptance device, or a hybrid mix of criteria as suits the needs of the merchant with multiple payment acceptance devices in one location, multiple locations, or receiving different types of payments (e.g., card present and card not present transactions). A second data field may include a transaction type identifier 604. The transaction type identifier 604 can include an identifier for the type of transaction, for example, credit card transaction, debit card transaction, stored value card transaction, online transaction, small ticket purchase, large ticket payment, utility payment, transportation payment, etc. As such, each type of transaction for the merchant may have a different set of criteria. A third data field may be one or more criteria 606. The criteria 606 may include any characteristic of a standard and/or non-standard transaction. The criteria may be referred to as a standard transaction profile. For example, a standard transaction for the type of transaction may be described, such as, credit card present, magnetic stripe read, zip code entered, customer identification checked, etc. Then, any differences from the standard transaction are determined for transactions. In another embodiment, any non-standard characteristic is identified, for example, no card present, credit card number entered via user interface, zip code not entered or incorrect, customer identification not present, etc. Then, any similarity between the transaction characteristics and the criteria are determined.

A further data field may include threshold criteria 608. The threshold criteria 608 can include any characteristic of one or more non-standard transactions that will require a notice to be sent to the merchant. For example, if there is any non-standard transaction, a notice is required or if there are three non-standard transactions in a single day, a notification is needed. In another example, if three non-standard transactions occur at the same point-of-sale device, a notification is needed.

Another data field may be the notification procedures 610. The notification procedures 610 can provide requirements for the notification. For example, the notification procedures can include the information the merchant will require in the notification, what medium to use for the notification, e.g., email, fax, etc., to whom the notification is to be sent, etc. This information is provided by the merchant and accessed and used by the application 200.

Referring again to FIG. 2, the application 200, in embodiments, includes a transaction receiver 212. The transaction receiver 212 is operable to receive the transaction information 210 (similar or the same as transaction information 116 described in conjunction with FIG. 1A) from the merchant 112 (FIG. 1A). The transaction receiver 212 can include a communications interface to a network, such as the Internet, and any software or hardware to read the transaction information 210. The transaction receiver 212 receives the transaction information 210 and sends the transaction information 210 to a transaction qualifying analyzer 214.

In embodiments, the transaction qualifying analyzer 214 determines if the transaction associated with the transaction information received by transaction qualifying analyzer 214 will create an increased interchange fee. The transaction qualifying analyzer 214 can read the criteria from the criteria database 208 and compare the criteria with the transaction information 210. If the transaction information 210 does not deviate from the standard transaction profile, the transaction qualifying analyzer 214 can determine the transaction is qualifying, and the transaction will continue as explained in conjunction with FIG. 1A. However, if there is one or more deviations between the transaction information 210 and the criteria, the transaction qualifying analyzer 214 can determine that a non-qualifying transaction is occurring. For example, if the criteria shows that a standard transaction requires the customer to provide his or her zip code and the customer does not provide his or her zip code, the transaction qualifying analyzer 214 determines the transaction is a non-qualifying transaction. In embodiments, the transaction qualifying analyzer 214 stores the non-qualifying transaction in a non-qualifying transaction datastore 216. The standard transaction profile may relate to a store, a district, a company, a line of business, or any other level of customization.

The non-qualifying transaction datastore 216 can be any type of memory that stores information associated with one or more non-qualifying transactions. In an embodiment, the non-qualifying transaction datastore 216 is a log listing the non-qualifying transactions in chronological order. In other embodiments, the non-qualifying transactions are stored in some other format. Each record of a non-qualifying transaction may include one or more portions of the transaction information 210 associated with the transaction.

A threshold analyzer 218, in embodiments, determines if a threshold for generating a notification is passed. A threshold is a criteria 202 received from the merchant and stored in the criteria database 208 for when the merchant wants a notice for one or more non-qualifying transactions. In an embodiment, every non-qualifying transaction generates a notice of an increased interchange fee. In alternative embodiments, two or more non-qualifying transactions that meet predetermined threshold criteria are received before the threshold analyzer 218 determines a notice is needed. For example, if three non-qualifying transactions occur in a single day, a notice may be generated. However, if only a single non-qualifying transaction occurs in a singe day, no notice may be needed. In another example, if three non-qualifying transactions occur on the same point-of-sale device 118 in a week, a notice may be generated to alert the merchant that the point-of-sale device 118 may be malfunctioning. In embodiments, there are two or more threshold criterion 202 that are analyzed for the non-qualifying transactions.

In another embodiment, the threshold analyzer 218 analyzes the non-qualifying transaction 216 using a pattern analysis algorithm or other algorithm. The different algorithms may be stored in the criteria database 208 and specified by the merchant. One skilled in the art will recognize different pattern analysis algorithms that may be used to analyze the transactions. For example, the algorithm may try to match non-standard transactions 216 to dates created or employees involved. This analysis has the advantage of identifying other reasons for increased interchange fees beyond the capabilities of simple threshold criteria comparisons described above.

The threshold analyzer 218, upon receiving indication that a new non-qualifying transaction is stored in the non-qualifying transaction datastore 216, the threshold analyzer 218 can review the record in the non-qualifying transaction datastore 216 to determine if more non-qualifying transactions have occurred over a period of time. If enough non-qualifying transactions have occurred to pass a threshold condition, the threshold analyzer 218, in embodiments, sends an indication to a near real time notifier 224. In other embodiments, the threshold analyzer 218 sends information from the non-qualifying transaction datastore 216 for one or more non-qualifying transactions to a reporter 220.

The reporter 220, in embodiments, generates a summary report 222 for one or more non-qualifying transactions that have occurred and are stored in the non-qualifying transaction datastore 216. For example, every month, the reporter 220 compiles a list of all the non-qualifying transactions stored in the non-qualifying transaction datastore 216. One or more items of transaction information 210 stored in the non-qualifying transaction datastore 216 populates the summary report 222. The reporter 220 can then send the summary report 222 to the merchant. The summary report 222 allows the merchant to receive information about non-qualifying transactions that do not necessarily generate a notice.

In embodiments, the near real time notifier 224 receives a indication that an increased interchange fee notification 226 needs to be sent. The near real time notifier 224 creates the notification 226, which may be an email, other electronic message, a fax, a paper message, or other notice. The threshold analyzer 218, in embodiments, provides one or more items of transaction information 210 for the notice. In other embodiments, the near real time notifier 224 retrieves transaction information from the non-qualifying transaction datastore 216. The near real time notifier 224 writes the transaction information 210 to the notification 226 and sends the notification 226 to the merchant.

The notification 226 may have one or more items of transaction information 210, for example, merchant, transaction identifier, point-of-sale device identifier, sales person identifier, reason for increased interchange fee, etc. The notification 226 can include any transaction information 210 required by the merchant to respond to the reasons for the increased interchange fee. What information is included in the notice may be part of the criteria 202 stored in the criteria database 208 and read by the near real time notifier 224.

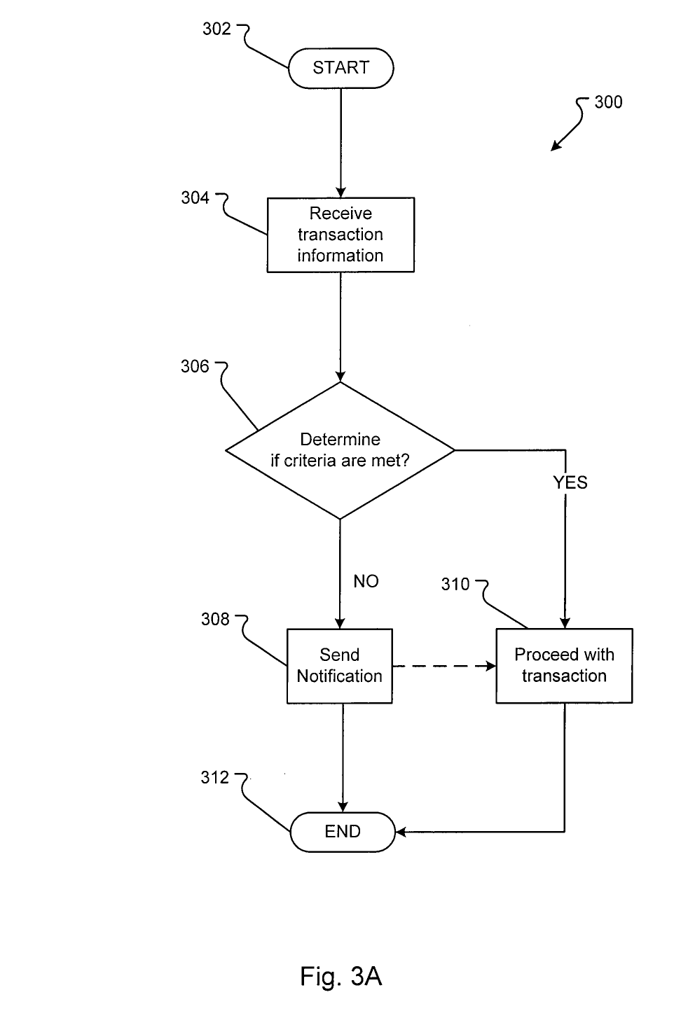

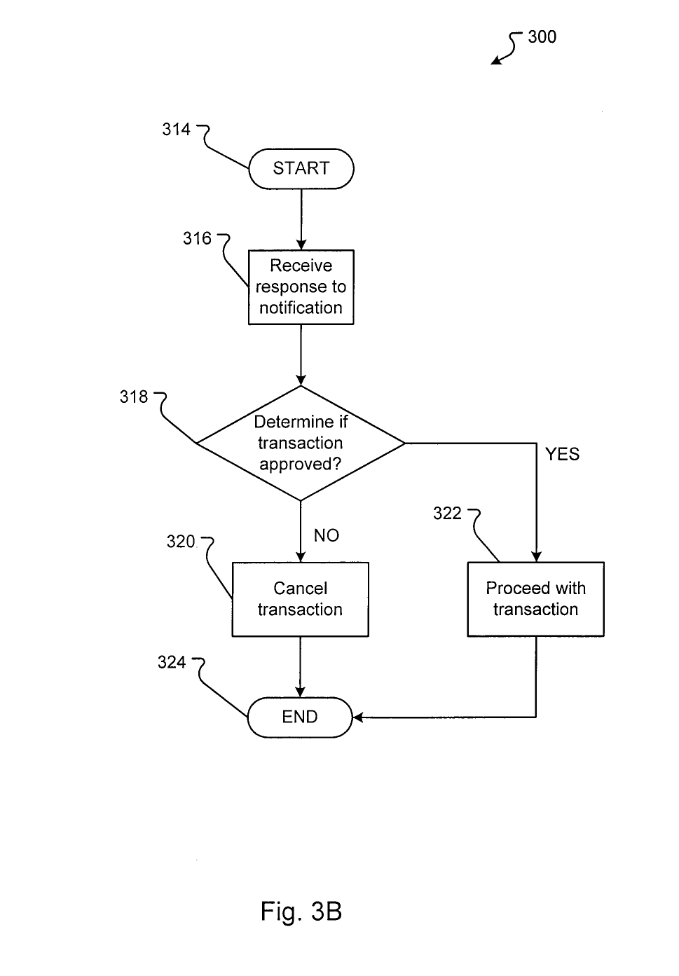

A flow diagram of a method 300 for determining that a notice is to be sent because an increased interchange fee is to be assessed is shown in FIG. 3A. In embodiments, the method 300 generally begins with a START operation 302 and terminates with an END operation 312. The steps shown in the method 300 may be executed in a computer system as a set of computer-executable instructions. While a logical order is shown in FIG. 3A, the steps shown or described can, in some circumstances, be executed in a different order than presented herein.

Receive operation 304 receives transaction information. In embodiments, the merchant 112 (FIG. 1A) receives transaction information 116 (FIG. 1A). The merchant 112 (FIG. 1A) may receive credit card information or other types of transaction information from a point-of-sale device 118 (FIG. 1B). The transaction information may be sent to the application 108 (FIG. 1A) and received by the application 108 (FIG. 1A). In embodiments, a transaction receiver 212 (FIG. 2) of the application 108 (FIG. 1A) receives the transaction information.

Determine operation 306 determines if the criteria are met. In embodiments, the application 108 (FIG. 1A) determines if the transaction meets the criteria for a non-qualifying transaction. A transaction qualifying analyzer 214 (FIG. 2) of the application 108 (FIG. 1A) can read criteria from a criteria database 208 (FIG. 2). The criteria may be compared to the transaction information received by the application 108 (FIG. 1A). In an embodiment, if the transaction information deviates from the criteria establishing a qualifying or standard transaction, the transaction is non-qualifying and the method 300 flows NO to send operation 308. In another embodiment, if the transaction information matches any of the criteria establishing a non-qualifying or non-standard transaction, the transaction is non-qualifying and the method 300 flows NO to send operation 308. If the method is qualifying, the method 300 flows YES to proceed operation 310. Proceed operation 310 proceeds with the transaction as described in FIG. 1A.

Send operation 308 sends a notification of a non-qualifying transaction or an increased interchange fee notification. In embodiments, the application 108 (FIG. 1A) sends the notification 114 (FIG. 1A) to the merchant 112 (FIG. 1A). The near real time notifier 224 of the application 108 (FIG. 1A) can generate the notification 226 (FIG. 2) to send to the merchant, other entity, or other person. In an embodiment, the method 300 continues to proceed operation 310 even after or while send operation 308 sends the notification.

A further embodiment of the method 300 is shown in FIG. 3B. In embodiments, the method 300 in FIG. 3B generally begins with a START operation 314, which can occur after send operation 308 (FIG. 3A) and terminates with an END operation 324. The steps shown in the method 300 may be executed in a computer system as a set of computer-executable instructions. While a logical order is shown in FIG. 3B, the steps shown or described can, in some circumstances, be executed in a different order than presented herein.

Receive operation 316 receives a response to the notification. In embodiments, the merchant 112 (FIG. 1A) receives the notification 114 (FIG. 1A). For example, the notification 114 (FIG. 1A) is received at a point-of-sale device 118 (FIG. 1B) and displayed on a user interface 120 (FIG. 1B). The merchant 112 (FIG. 1A) may accept the notification and send a response back to the application 108 (FIG. 1A). For example, the sale person using the point-of-sale device 118 (FIG. 1B) selects a device on the user interface 120 (FIG. 1B) to accept the notification and the increased interchange fee. The application 108 (FIG. 1A) receives the response to the notification.

Determine operation 318 determines if the transaction is approved. In embodiments, the merchant 112 (FIG. 1A) approves the transaction with the increased interchange fee. The application 108 (FIG. 1A) may also receive a rejection of the transaction with the increased interchange fee. If the transaction is approved by the merchant 112 (FIG. 1A), the method 300 flows YES to proceed operation 322. Proceed operation 322 proceeds with the transaction as described in FIG. 1A. If the transaction is not approved, the method 300 flows NO to cancel operation 320. Cancel operation 320 cancels the transaction by preventing the transaction to continue on to the merchant acquirer 106 (FIG. 1A) or by sending an indication to cancel the transaction to the merchant acquirer 106 (FIG. 1A).

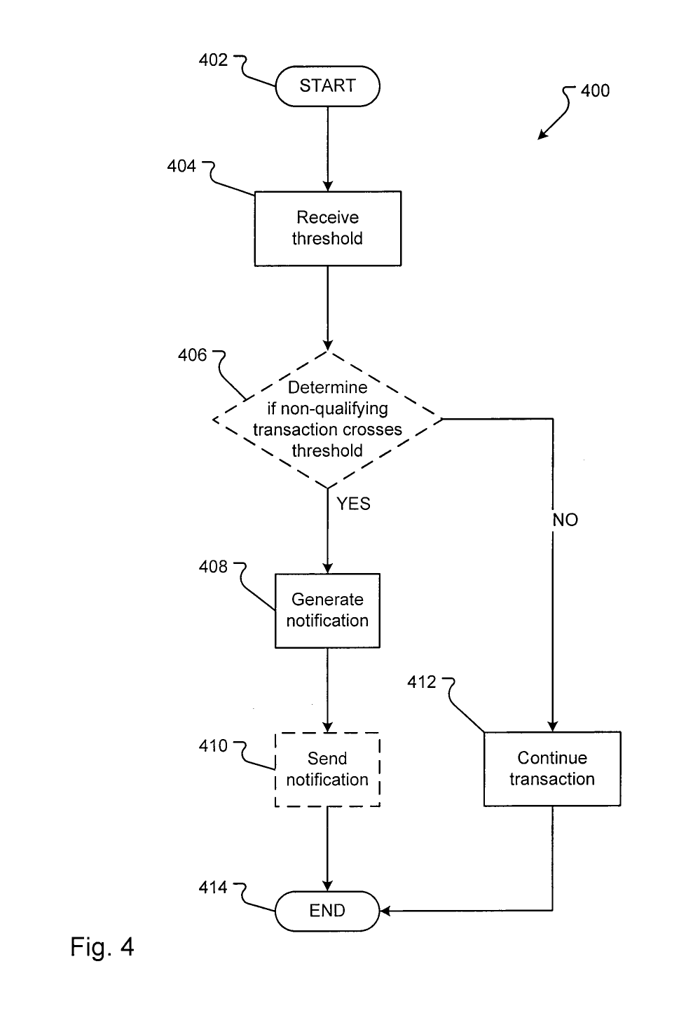

A flow diagram of a method 400 for determining that a notice is to be sent because an increased interchange fee is to be assessed is shown in FIG. 4. In embodiments, the method 400 generally begins with a START operation 402 and terminates with an END operation 414. The steps shown in the method 400 may be executed in a computer system as a set of computer-executable instructions. While a logical order is shown in FIG. 4, the steps shown or described can, in some circumstances, be executed in a different order than presented herein.

Receive operation 404 receives a threshold. In embodiments, the merchant 112 (FIG. 1A) provides a threshold to the application 108 (FIG. 1A). The merchant 112 (FIG. 1A) may interface with the merchant register 204 (FIG. 2) to provide criteria 202 (FIG. 2) that includes threshold criteria. The merchant register 204 (FIG. 2) receives the threshold criteria and stores the threshold criteria in a criteria database 208 (FIG. 2). The threshold criteria can specify when the application 108 (FIG. 1A) is to send a notification because of a non-qualifying transaction. For example, if three non-qualifying transactions occur in an hour at the same point-of-sale device 118 (FIG. 1B), a notification is to be sent.

Determine operation 406 determines if the non-qualifying transaction meets the threshold criteria. In embodiments, the application 108 (FIG. 1A) determines if the transaction meets the threshold criteria for a non-qualifying transaction. A transaction qualifying analyzer 214 (FIG. 2) of the application 108 (FIG. 1A) can read the threshold criteria from the criteria database 208 (FIG. 2). The threshold criteria may be compared to one or more sets of transaction information received by the application 108 (FIG. 1A). In an embodiment, if one or more of the transactions deviate from the threshold criteria, the threshold criteria are not met and the method 400 flows NO to continue operation 412. Continue operation 412 continues the transaction as described in FIG. 1A. In another embodiment, if the transaction information matches or surpasses the threshold criteria, the one or more transactions meet the threshold criteria and the method 400 flows YES to generate operation 408. The threshold criteria, in embodiments, may also evaluate the number of deviating transactions relative to the number of qualifying transactions. This volume ratio or volume threshold may be compared to other comparable stores to determine if one store, employee, or other entity may have problems with too many non-qualifying transactions.

Generate operation 408 generates a notification for one or more non-qualifying transactions or one or more increased interchange fee notifications. In embodiments, the application 108 (FIG. 1A) generates the notification 114 (FIG. 1A) for the merchant 112 (FIG. 1A). The near real time notifier 224 of the application 108 (FIG. 1A) can generate the notification 226 (FIG. 2) to send to the merchant, other entity, or other person. In an embodiment, the method 400 continues to send operation 410 to send the notification. In an alternative embodiment, the reporter 220 (FIG. 2) of the application 108 (FIG. 1A) can generate a report 222 (FIG. 2) to notify the merchant, other entity, or other person. In an embodiment, the method 400 continues to send operation 410 to send the notification. Send operation 410 sends the notification. In further embodiments, the notification 114 (FIG. 1A) can include the number of non-standard transactions or the amount of an increased interchange fee for one or more non-standard transactions. For example, 1000 transactions were non-standard over a predetermined period of time and the 1000 transactions created $100 in increased interchange fees.

Embodiments of the different systems represented in this disclosure, which may include the merchant 112 (FIG. 1A), the application 108 (FIG. 1A), the merchant acquirer 106 (FIG. 1A), and/or the issuing bank 102 (FIG. 1A), may be a computer system, such as computer system 500 shown in FIG. 5. A basic computer system is shown as one skilled in the art will recognize the technical changes and modifications that may be required to make the systems described herein operable. The computer system 500 comprises a processor 502, which completes the operations described in conjunction with FIGS. 3A through 4 or makes the systems operable described in conjunction with FIGS. 1A through 2. The processor 502 may be any type of processor operable to complete the operations or implement the systems described herein. For example, the processor 502 may be an Intel Pentium processor, an ASIC, an FPGA, or other device.

The computer system 500 also comprises memory 504 to hold data or code being executed by processor 502. The memory 504 may permanently or temporarily store the instructions described in conjunction with FIGS. 3A through 4 or the data elements described in conjunction with FIG. 2. Memory may be classified as computer readable medium, for example, RAM, ROM, magnetic media, optical media, etc.

The computer system 500 also can comprise software elements, including an operating system and/or other code, such as one or more application programs for generating a notification 114 (FIG. 1A) to send to the merchant 112 (FIG. 1A). The application programs may comprise computer programs described herein, and/or may be designed to implement methods described herein and/or configure systems described herein. Merely by way of example, one or more procedures described with respect to the method(s) discussed in conjunction with FIGS. 3A through 4 might be implemented as code and/or instructions executable by the computer system 500 (and/or the processor 502 within the computer 500).

A set of these instructions and/or code might be stored on a computer readable storage medium, such as the storage device(s) 508 or memory 504. In some cases, the storage medium might be incorporated within a computer system. In other embodiments, the storage medium might be separate from a computer system (i.e., a removable medium, such as a compact disc, etc.), and/or provided in an installation package, such that the storage medium can be used to program a general purpose computer with the instructions/code stored thereon. These instructions might take the form of executable code, which is executable by the computer system 500 and/or might take the form of source and/or installable code, which, upon compilation and/or installation on the computer system 500 (e.g., using any of a variety of generally available compilers, installation programs, compression/decompression utilities, etc.) then takes the form of executable code.

Further embodiments of the computer system 500 comprises input/output (I/O) modules or systems 506. I/O systems 506 may include displays such as LCDs, plasma screen, cathode ray tubes, etc. The displays can provide a visual representation of data to a user. I/O system 506 may also include input devices such as mice, keyboards, touch screens, etc. Input devices allow the user to input information into the computer system. I/O systems 506 may also comprise communication systems such as wired, wireless, or other communication systems. Further, communication systems may communicate with peripheral devices, such as printers, modems, or other devices. As an example, the user interface 120 (FIG. 1B) of the point-of-sale device 118 (FIG. 1B) may be one or more of the I/O systems 506 described herein.

In light of the above description, a number of advantages of the present disclosure are readily apparent. For example, the merchant can receive notices that increased interchange fees are being incurred in near real time. As such, the merchant has the opportunity to ameliorate the problem causing the increased interchange fees. The merchant may also receive reports to determine patterns or tendencies in which increased interchange fees occur. In other embodiments, the merchant can approve the increased interchange fee before the fee is assessed. All these advantages help the merchant lower their costs for using credit cards, debit cards, etc.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

While the principles of the disclosure have been described above in connection with specific apparatuses and methods, it is to be clearly understood that this description is made only by way of example and not as limitation on the scope of the invention.

What is claimed is:

1. A system for generating a notification for an increased interchange fee, the system comprising:
a merchant system, the merchant operable to receive information associated with a transaction from a customer, wherein the transaction is a non-cash transaction, the merchant system operable to display the notification of an increased interchange fee;
an application, the application operable to receive the information associated with the transaction, the application determining if the transaction will create the increased interchange fee, the application generating the notification associated with the increased interchange fee, and the application sending the notification to the merchant system; and
a network, the network in communication with the merchant system and the application, the network operable to communicate transaction information to the application, the network operable to communicate the notification to the merchant system.

2. The system as defined in claim 1, wherein the merchant system comprises:
a user interface, the user interface operable to provide information about a transaction, the user interface operable to display the notification, the user interface operable to receive an approval of the increased interchange fee associated with the notification, the user interface operable to send the approval to the point-of-sale device; and
a point-of-sale device in communication with the user interface, the point-of-sale device operable to receive the information associated with the transaction, the point-of-sale device operable to send the information associated with the transaction to the application, the point-of-sale device operable to receive the notification from the application and provide the notification to the user interface, and the point-of-sale device operable to complete the transaction if the approval of the increased interchange fee is received from the user interface.

3. The system as defined in claim 2, wherein the application is part of the point-of-sale device.

4. The system as defined in claim 1, further comprising:
a merchant acquirer in communication with the application, the merchant acquirer processing the transaction;
an issuing institution, the issuing institution operable to approve the transaction and operable to send an approval of the transaction to the merchant acquirer; and
a switching network in communication with the merchant acquirer and the issuing institution, the switching network operable to route the information associated with the transaction to the issuing institution, and the switching network operable to route the approval to the merchant acquirer.

5. The system as defined in claim 4, wherein the application is part of the merchant acquirer.

6. The system as defined in claim 1, wherein the notification is sent in near real time to the merchant.

7. The system as defined in claim 1, wherein the application compares the information associated with the transaction with data for a standard transaction profile stored in a database, if the transaction qualification information is different than the data for the standard transaction qualification profile, the application generates the notification.

8. The system as defined in claim 7, wherein the data for the standard transaction profile is associated with one of a group consisting of a standard transaction profile for a store, a standard transaction profile for a district, a standard transaction profile for a company, and a standard transaction profile for a line of business.

9. The system as defined in claim 1, wherein the application compares the information associated with the transaction with data for non-standard transactions stored in a database, if the information is the same as the data for the non-standard transactions, the application generates the notification.

10. The system as defined in claim 9, wherein the data for the non-standard transactions is associated with one of a non-standard transaction for a store, a non-standard transaction for a district, and a non-standard transaction for a company.

11. The system as defined in claim 1, wherein the information associated with the transaction is information about a credit card, a debit card, a stored value card, a customer, a good, a service, and a price for the good or the service.

12. The system as defined in claim 1, wherein the notification is sent by one of email, facsimile, or electronic message.

12. The system as defined in claim 1, wherein the information associated with the transaction is analyzed with an algorithm to identify patterns in the information.

13. The system as defined in claim 1, wherein the information associated with the transaction is analyzed to determine a volume ratio.

14. A method for generating a notification associated with an increased interchange fee, the method comprising:
receiving transaction information regarding a transaction wherein the transaction is a non-cash transaction;
determining, from the transaction information, if the increased interchange fee will be assessed wherein if an increased interchange fee is to be assessed, the transaction is non-qualifying;
if the increased interchange fee will be assessed, generating the notification;
if the increased interchange fee will not be assessed, completing the transaction; and
sending the notification to a merchant.

15. The method as defined in claim 14, further comprising:
receiving a response to the notification;
if the response approves increased interchange fee, completing the transaction; and
if the response does not approve the increased interchange fee, cancelling the transaction.

16. The method as defined in claim 14, wherein determining comprises:
comparing the transaction information to data for a standard transaction;
if the transaction information is different from the data for the standard transaction, generating the notification; and
if the transaction information is not different from the data for the standard transaction, completing the transaction.

17. The method as defined in claim 16, wherein comparing comprises:
storing transaction information for one or more transactions that are different from the data for a standard transaction;
comparing the one or more stored transactions with a threshold;
determining if the one or more stored transactions cross the threshold;
if the one or more stored transactions cross the threshold, generating the notification; and
if the one or more stored transactions do not cross the threshold, completing the transaction.

18. The method as defined in claim 14, wherein the threshold includes one or more criteria received from the merchant for when the notification should be sent.

19. The method as defined in claim 14, wherein determining comprises:
comparing the transaction information to data for a non-standard transaction;
if the transaction information is the same as the data for the non-standard transaction, generating the notification; and
if the transaction information is different from the data for the non-standard transaction, completing the transaction.

20. An application for generating a notification for an increased interchange fee, the application comprising:
instructions for a transaction receiver, the transaction receiver operable to receive transaction information regarding a transaction;
instructions for a transaction qualifying analyzer, the transaction qualifying analyzer operable to compare the transaction information to one or more criteria stored in a criteria database, the transaction qualifying analyzer operable to store non-qualifying transactions in a non-qualifying transaction datastore, wherein the increased interchange fee will be assessed if the transaction is a non-qualifying transaction;
instructions for a threshold analyzer, the threshold analyzer operable to compare the stored non-qualifying transactions to one or more thresholds stored in the criteria database, the threshold analyzer operable to determine if the one or more stored non-qualifying transactions cross a threshold, the threshold analyzer operable to send an indication that the notification should be sent; and
instructions for a near real time notifier, the near real time notifier operable to receive the indication that the notification should be sent, the near real time notifier operable to generate the notification, the near real time notifier operable to send the notification in near real time to the merchant.

21. The application as defined in claim 20, the application further comprising:
instructions for a reporter, the reporter operable to periodically generate a summary report of one or more non-qualifying transactions, the reporter operable to periodically send the summary report to the merchant.

22. The application as defined in claim 20, further comprising:
instructions for a merchant register, the merchant register operable to receive the one or more criteria from the merchant, the merchant register operable to store the one or more criteria in the criteria database.

23. The application as define in claim 23, wherein the merchant register is operable to receive the one or more threshold criteria, the merchant register operable to store the one or more threshold criteria in the criteria database.
